(19) United States
(12) Patent Application Publication
(10) Pub. No.: US 2002/0180683 A1
(43) Pub. Date: Dec. 5, 2002

(54) Driver for a liquid crystal display and liquid crystal display apparatus comprising the driver

(76) Inventors: Tsukasa Yagi, Kobe-shi (JP); Shuji Yoneda, Osaka-Shi (JP)

Correspondence Address: SIDLEY AUSTIN BROWN & WOOD LLP, 717 NORTH HARWOOD, SUITE 3400, DALLAS, TX, 75201, US

(21) Appl. No.: 10/108,958

(22) Filed: Mar. 28, 2002

(30) Foreign Application Priority Data
Mar. 30, 2001 (JP) 2001-102428

(51) Int. Cl. G09G 3/36

(52) U.S. Cl. 345/98

(57) ABSTRACT

A driver for driving a liquid crystal display by a matrix method. The driver drives the liquid crystal display by applying pulses to a plurality of scanning electrodes and a plurality of signal electrodes which cross each other substantially perpendicularly and face each other. A circuit for driving the scanning electrodes has, in addition to a shift register, a phase latch, a decoder and an analog switch, another shift register and a mask latch. The mask latch controls whether or not to output a driving pulse to each scanning electrode so that the frequency of transmission clock during writing on part of the screen will not be higher.

### RELATED APPLICATIONS

This application is based on Japanese Patent Application No. 2001-102428, filed Mar. 30, 2001, the contents of which are hereby incorporated by reference.

### BACKGROUND OF THE INVENTION

1. Field of the Invention

The present invention relates to a driver for a liquid crystal display and a liquid crystal display apparatus, and more particularly to a driver for driving liquid crystal by a matrix method and a liquid crystal display apparatus comprising the driver.

2. Description of Prior Art

In recent years, liquid crystal displays which use liquid crystal which exhibits a cholesteric phase at room temperature, such as chiral nematic liquid crystal, attract attention as small, light and energy-saving displays because such liquid crystal has a memory effect and displays an image thereon continuously even after stoppage of an electric supply thereto.

Such a liquid crystal display is driven by a simple matrix method, and more specifically, is driven by pulses applied thereto through a plurality of scanning electrodes and a plurality of signal electrodes which cross and face each other. There may be a case of driving the liquid crystal display for writing on the entire screen and may be a case of driving the liquid crystal display for writing on only part of the screen. Conventionally, even in the latter case, data on all the scanning lines including the scanning lines which are not in the part subjected to writing are renewed, and there is a case that data transmission must be carried out at such a high speed as to be a thousand times the speed for writing on the entire screen.

### SUMMARY OF THE INVENTION

An object of the present invention is to provide a driver for a liquid crystal display which drives a liquid crystal display for writing on a part of the screen at a data transmission speed which is equal to the data transmission speed for writing on the entire screen, and a liquid crystal display apparatus provided with this driver.

In order to attain the object, according to the present invention, a driver which carries out simple matrix driving of a liquid crystal display by applying pulses to a plurality of scanning electrodes and a plurality of signal electrodes which face each other and cross each other substantially perpendicularly is provided with a mask bit register for controlling whether or not to apply driving pulses to each of the scanning electrodes.

In the driver according to the present invention, the mask bit register controls whether or not to apply driving pulses to each of the scanning electrodes. Thereby, during writing on part of the liquid crystal display, it is no longer necessary to send data to the scanning lines in the other part of the display. Accordingly, it is not necessary to send data at a higher speed than the data sending speed during writing on the entire liquid crystal display.

In the driver according to the present invention, therefore, the mask bit register is preferably used for writing on part of the liquid crystal display and also may be used for interlace scanning which is a form of partial writing.

Also, the liquid crystal display which is driven by the driver according to the present invention preferably comprises liquid crystal with a memory effect. Such a display which comprises liquid crystal with a memory effect is small, light and thin. Such a display also has the advantage of displaying an image thereon continuously after stoppage of a supply of electric power thereto, thereby reducing the consumption of electric power.

Further, a liquid crystal display apparatus according to the present invention comprises a liquid crystal display which has liquid crystal between a pair of substrates, and the above-described driver. The liquid crystal in the liquid crystal display preferably has a memory effect and/or exhibits a cholesteric phase.

### BRIEF DESCRIPTION OF THE DRAWINGS

This and other objects and features of the present invention will be apparent from the following description with reference to the accompanying drawings, in which:

FIG. 1 is a sectional view of an exemplary liquid crystal which can be driven by a driver according to the present invention;

FIG. 2 is a block diagram which shows the control circuit of the liquid crystal display;

FIG. 3 is a chart which shows a basic driving wave which is outputted from a scanning electrode driving IC;

FIG. 4 is a chart which shows a state where basic driving waves are outputted sequentially;

FIG. 5 is a chart which shows a writing wave applied to liquid crystal;

FIG. 6 is a chart which shows driving waves when matrix-driving of liquid crystal is carried out;

FIG. 7 is a block diagram which shows an exemplary scanning electrode driving IC;

FIG. 8 is a chart which shows driving waves for writing on the entire screen;

FIG. 9 is a chart which shows driving waves for writing on part of the screen;

FIG. 10 is a chart which shows driving waves for interlace scanning of liquid crystal; and

FIG. 11 is a block diagram which shows another exemplary scanning electrode driving IC.

### DETAILED DESCRIPTION OF THE PREFERRED EMBODIMENTS

Embodiments of a liquid crystal display driver and a liquid crystal display apparatus comprising the driver according to the present invention are hereinafter described with reference to the accompanying drawings.

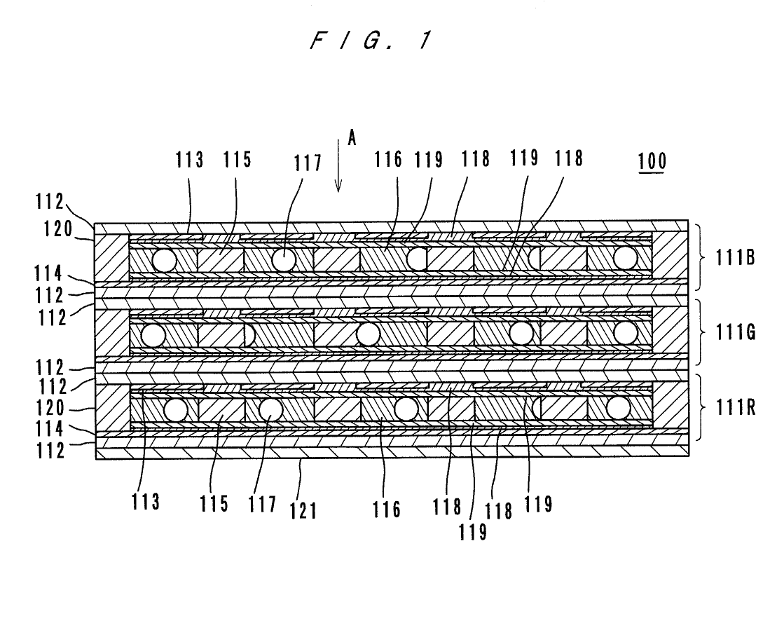

### Liquid Crystal Display; See FIG. 1

FIG. 1 shows a reflective type full-color liquid crystal display which is driven by a simple matrix method. This liquid crystal display 100 has a red display layer 111R, a green display layer 111G and a blue display layer 111B which are laminated on a light absorbing layer 121. The red display layer makes a display by switching between a selective reflection state to reflect light of red and a transparent state, the green display layer 111G makes a display by switching between a selective reflection state to reflect light of green and a transparent state, and the blue display layer 111B makes a display by switching between a selective reflection state to reflect light of blue and a transparent state.

Each of the display layers 111R, 111G and 111B has, between transparent substrates 112, on which transparent electrodes 113 and 114 are formed respectively, resin nodules 115, liquid crystal 116 and spacers 117. An insulating layer 118 and an alignment controlling layer 119 may be provided on the transparent electrodes 113 and 114 if necessary. Further, around the substrates 112 (outside a displaying area), a sealant 120 is provided to seal the liquid crystal 116 therein.

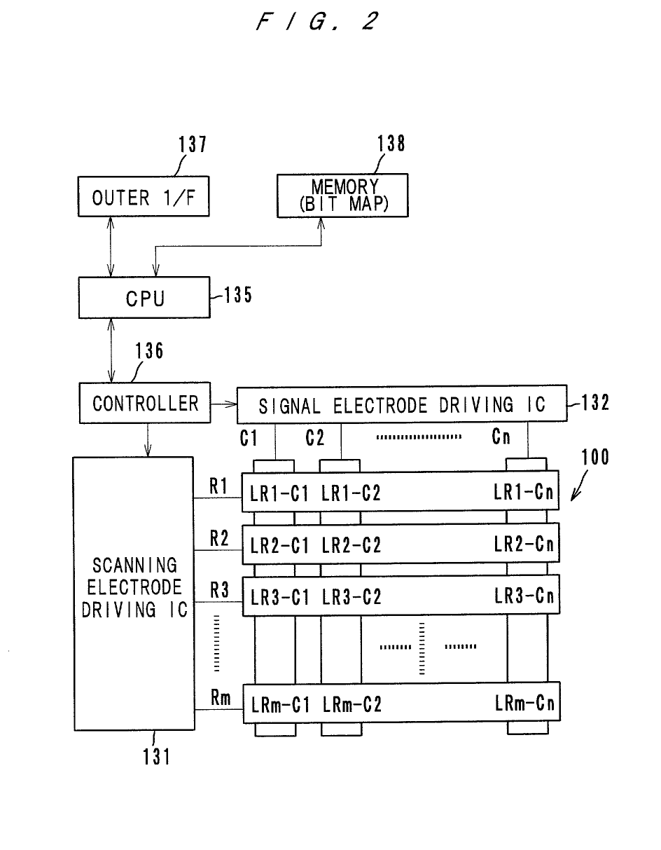

The transparent electrodes 113 and 114 are connected to driving ICs 131 and 132 (see FIG. 2), so that specified pulse voltages can be applied between the transparent electrodes 113 and 114. In response to the voltages applied, the liquid crystal 116 switches between a transparent state to transmit visible light and a selective reflection state to selectively reflect light of a specified wavelength.

The transparent electrodes 113 and 114 in each of the display layers 111R, 111G and 111B are strip-like electrodes which extend in parallel at fine intervals, and the strip-like electrodes 113 and the strip-like electrodes 114 cross each other at a right angle. These upper and lower electrodes are electrified sequentially. In other words, a voltage is applied to the liquid crystal 116 in a matrix way to make a display. This is referred to as matrix driving, and the intersections between the electrodes 113 and 114 function as pixels. By carrying out matrix driving in each of the display layers, the liquid crystal display 100 makes a full-color display.

A liquid crystal display which has liquid crystal between two substrates makes a display by switching the liquid crystal between a planar state and a focal-conic state. When the liquid crystal is in the planar state, the liquid crystal selectively reflects of a wavelength λ=Pn (P: helical pitch of the cholesteric liquid crystal, n: average refractive index). When the liquid crystal is in the focal-conic state, if the wavelength of light selectively reflected by the liquid crystal is within the infrared spectrum, the liquid crystal scatters light, and if the wavelength of light selectively reflected by the liquid crystal is shorter than the infrared spectrum, the liquid crystal transmits visible light. Accordingly, by setting the wavelength of light selectively reflected by the liquid crystal within the visible spectrum and by providing a light absorbing layer on the side of the display opposite to the observing side, the liquid crystal display makes a display in the following ways: when the liquid crystal is in the planar state, the liquid crystal display makes a display of the color of the selectively reflected light; and when the liquid crystal is in the focal-conic state, the liquid crystal display makes a display of black. By setting the wavelength of light selectively reflected by the liquid crystal within the infrared spectrum and by providing a light absorbing layer on the side of the display opposite to the observing side, the liquid crystal display makes a display in the following ways: when the liquid crystal is in the planar state, the liquid crystal reflects light within the infrared spectrum but transmits light within the visible spectrum, and accordingly the liquid crystal display makes a display of black; and when the liquid crystal is in the focal-conic state, the liquid crystal scatters light, and accordingly the liquid crystal display makes a display of white.

In the liquid crystal display 100 in which the display layers 111R, 111G and 111B are laminated, by setting the liquid crystal in the blue display layer 111B and the liquid crystal in the green display layer 111G to a transparent state (focal-conic state) and by setting the liquid crystal in the red display layer 111R to a selective reflection state (planar state), the liquid crystal display 100 makes a display of red. By setting the liquid crystal in the blue display layer 111B to a transparent state (focal-conic state) and by setting the liquid crystal in the green display layer and the liquid crystal in the red display layer to a selection reflection state (planar state), the liquid crystal display 100 makes a display of yellow. In similar ways, by setting the liquid crystal in the respective display layers to a transparent state or to a reflective selection state appropriately, the liquid crystal display 100 can make displays of red, green, blue, white, cyan, magenta, yellow and black. Also, by setting the liquid crystal in the respective display layers 111R, 111G and 111B to an intermediate reflection state, the liquid crystal display 100 can make a display of an intermediate color. Thus, the liquid crystal display 100 can be used as a full-color display.

The liquid crystal 116 preferably exhibits a cholesteric phase at room temperature, and chiral nematic liquid crystal which can be obtained by adding a chiral agent to nematic liquid crystal is especially suited.

A chiral agent is an additive which, when it is added to nematic liquid crystal, twists molecules of the nematic liquid crystal. When a chiral agent is added to nematic liquid crystal, the liquid crystal molecules form a helical structure with uniform twist intervals, and thereby, the liquid crystal exhibits a cholesteric phase.

Each of the liquid crystal layers is not necessarily of this structure. The resin nodules may be formed into a lattice or may be omitted. Also, the liquid crystal layers may be of a liquid crystal composite layer type in which liquid crystal is dispersed in a conventional three-dimensional polymer net structure or in which a three-dimensional polymer net structure is formed in liquid crystal.

### Control Circuit; See FIG. 2

The pixel structure of the liquid crystal display is a matrix which is composed of a plurality of scanning electrodes R1, R2 through Rm and a plurality of signal electrodes C1, C2 through Cn, in which m and n are natural numbers. The scanning electrodes R1, R2 through Rm are connected to output terminals of a scanning electrode IC 131, and the signal electrodes C1, C2 through Cn are connected to output terminals of a signal electrode driving IC 132.

The scanning electrode driving IC 131 outputs a selective signal to a specified one of the scanning electrodes R1, R2 through Rm while outputting a non-selective signal to the other scanning electrodes. The scanning electrode driving IC 131 sends the selective signal to the scanning electrodes one by one switching at uniform time intervals. In the meantime, in order to write on the pixels in the selected scanning electrode, the signal electrode driving IC 132 outputs signals in accordance with image data to the signal electrodes C1, C2 through Cn simultaneously. For example, while the scanning electrode Ra is selected, in which a is a natural number not more than m, writing on the pixels LRa-C1 through LRa-Cn which are the intersections between the scanning electrode Ra and the signal electrodes C1, C2 through Cn is carried out. In each pixel, the voltage difference between the scanning electrode and the signal electrode is a writing voltage, and writing on the pixel is carried out in accordance with the writing voltage.

The control circuit is so structured that a controller 136 controlled by a CPU 135 drives the driving ICs 131 and 132. Also, to the CPU 135, an outer interface 137 and a bit map memory 138 are connected. The CPU 135 drives the driving ICs 131 and 132 via the controller 136 in accordance with image data stored in the memory 138, so that an image is written on the liquid crystal display 100. The driving ICs 131 and 132 are provided for each of the display layers 111R, 111G and 111B.

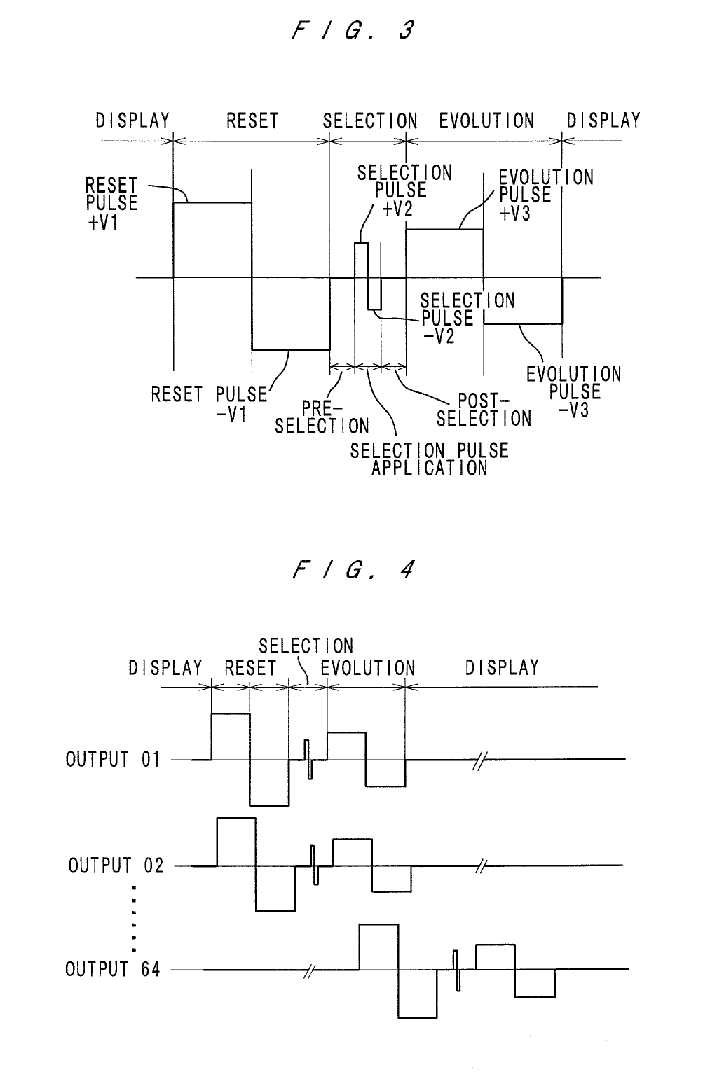

### Basic Driving Wave and Writing Wave; See FIGS. 3-5

FIG. 3 shows a basic driving wave which is outputted from the scanning driving IC 131 to the scanning electrodes. FIG. 4 shows the state where such basic waves are being applied to respective lines (scanning electrodes) sequentially.

A method of driving the liquid crystal comprises a reset step, a selection step, an evolution step and a display step. The selection step is composed of a pre-selection step, a selection pulse application step and a post-selection step, and in the selection pulse application step, a pulse of +V2 and a pulse of −V2 are applied.

The length of the selection pulse application step is a reference cycle. In the reset step, reset pulses +V1 and −V1 are applied, and each of the reset pulses has a width which is equal to the reference cycle. A series of these reset pulses is referred to as a reset wave. Likewise, in the evolution step, evolution pulses +V3 and −V3 are applied, and each of the evolution pulses has a width which is equal to the reference cycle. A series of these evolution pulses is referred to as an evolution wave. In the display step, a ground potential is outputted.

As FIG. 4 shows, such basic waves are applied to the respective scanning electrodes sequentially at lags of the reference cycle (the length of the selection pulse application step), and thereby, lines (scanning electrodes) are selected to be subjected to writing one from another.

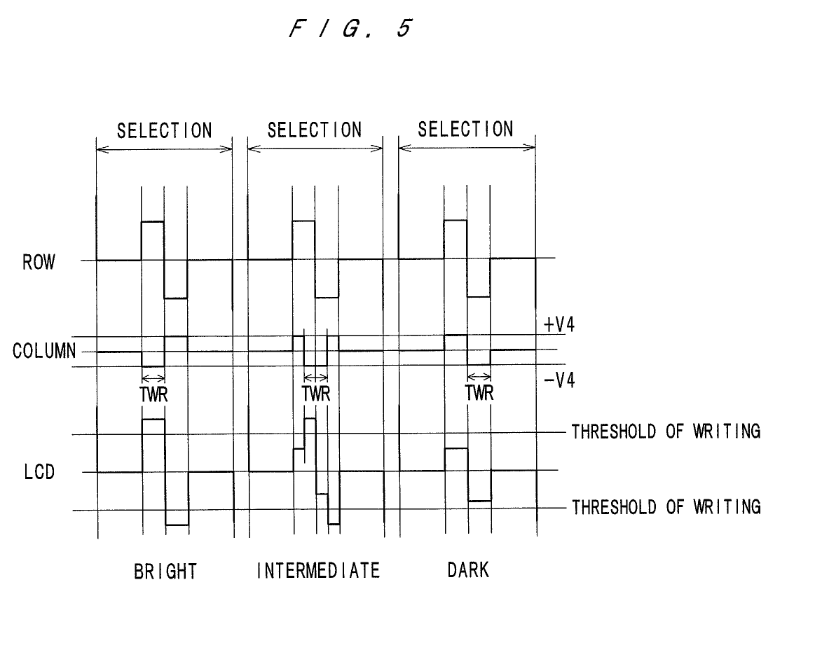

FIG. 5 shows a writing wave which actually acts on the liquid crystal. The writing wave is a combination of the basic driving wave applied to a scanning electrode, that is, a row wave and a wave which is outputted from the signal driving IC 132 to a signal electrode in accordance with image data, that is, a column wave.

In synchronization with the selection pulse, a signal pulse of −V4 with a width of TWR is outputted to the signal electrode, shifted in accordance with the piece of image data. By the combination of the signal pulse and the selection pulse, the voltage and the width of the writing wave is controlled. Thus, writing is carried out so as to cause each of the pixels to come to a bright state, an intermediate state or a dark state.

Now, the changes of the liquid crystal are described. First, when the reset wave is applied in the reset step, the liquid crystal is reset to a homeotropic state. Next, the ground potential is applied in the pre-selection step, and thereby, the liquid crystal is twisted a little. The form of the writing wave in the selection pulse application step depends on whether the pixel is desired to finally come to a planar state or to finally come to a focal-conic state.

In the case of selecting the pixel to finally come to a planar state, voltages of ±(V2+V4) act on the pixel in the selection pulse application step, and thereby, the liquid crystal of the pixel comes to the homeotropic state again. Thereafter, 0 volt acts on the liquid crystal in the post-selection step, and the liquid crystal comes to a slightly twisted state. Further, the evolution wave acts on the liquid crystal in the evolution step. Thereby, the liquid crystal which has been in the slightly twisted state in the post-selection step is untwisted and comes to the homeotropic state again. In the display step, crosstalk pulses are applied to the liquid crystal; however, the level of the crosstalk pulses is lower than the threshold to cause writing on the liquid crystal, and the liquid crystal is not influenced by the crosstalk pulses. Therefore, the liquid crystal in the homeotropic state comes to a planar state when the voltage applied thereto becomes zero.

In the case of selecting the pixel to finally come to a focal-conic state, in the selection pulse application step, the voltage applied to the liquid crystal is kept under the threshold to cause writing on the liquid crystal. More specifically, the signal pulse −V4 is shifted at the most, so that voltages of ±(V2−V4) act on the liquid crystal Next, 0 volt is applied in the post-selection step, and thereby the liquid crystal is twisted and comes to a transient planar state where the helical pitch is double. Thereafter, the evolution wave is applied, and the liquid crystal which has been twisted a little in the post-selection step comes to a focal-conic state. In the display step, as in the case of selecting the pixels to finally come to a planar state, crosstalk pulses are applied to the liquid crystal; however, the level of the crosstalk pulses is lower than the threshold to cause writing on the liquid crystal, and the liquid crystal is not influenced by the crosstalk pulses. Therefore, the liquid crystal in the focal-conic state stays in the same state even when the voltage applied thereto becomes zero.

Thus, the final state of the liquid crystal can be selected by the pulses applied in the selection pulse application step. Also, by changing the pulse width, it is possible to write intermediate tones.

In the wave described above, in the case of selecting the pixel to finally come to a focal-conic state, in the selection step after the application of the reset wave and before the application of the evolution wave, the liquid crystal is caused to come to a transient planar state. This step is referred to as a response step.

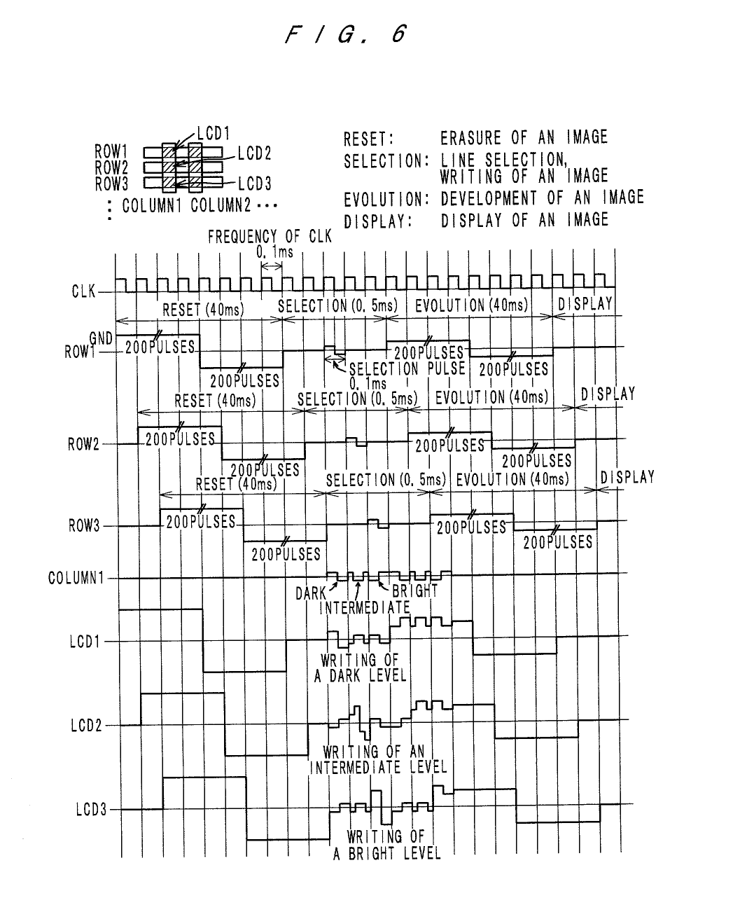

### Matrix Driving Wave; See FIG. 6

FIG. 6 shows driving waves to carry out matrix driving of the liquid crystal display layers 111R, 111G and 111B. In FIG. 6, control of three pixels denoted by LCD1, LCD2 and LCD3 is illustrated; however, more pixels can be controlled in the same way.

Basic driving waves are outputted to ROW1, ROW2 and ROW3 sequentially at lags of one clock which is the reference cycle, that is, the length of the selection pulse application step. Each row is supplied with reset pulses of +V1 and −V1, selection pulses of +V2 and −V2 and evolution pulses of +V3 and −V3 at specified intervals. Finally, a ground potential is applied. Thus, a sequence is completed.

As described above, a signal pulse in accordance with image data is outputted to COLUMN in synchronization with the selection pulse.

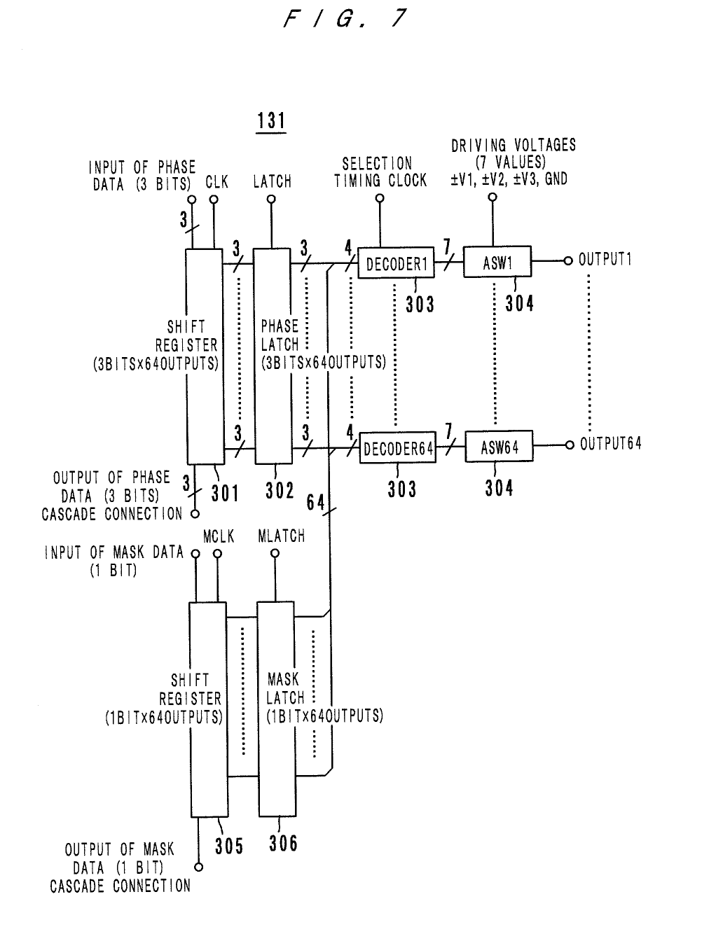

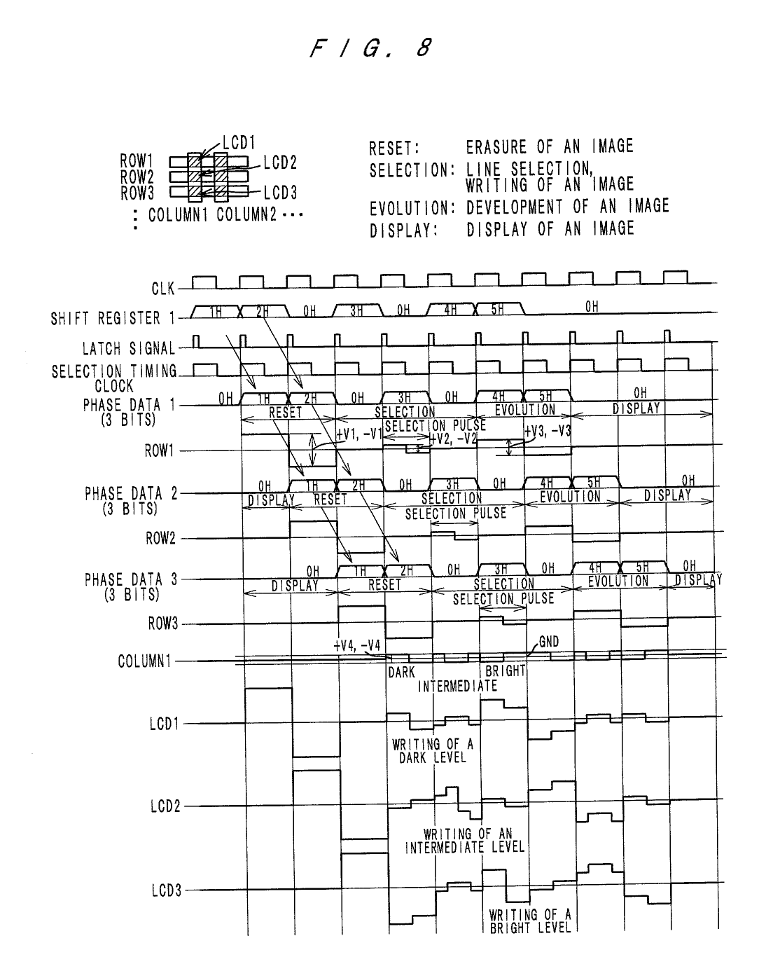

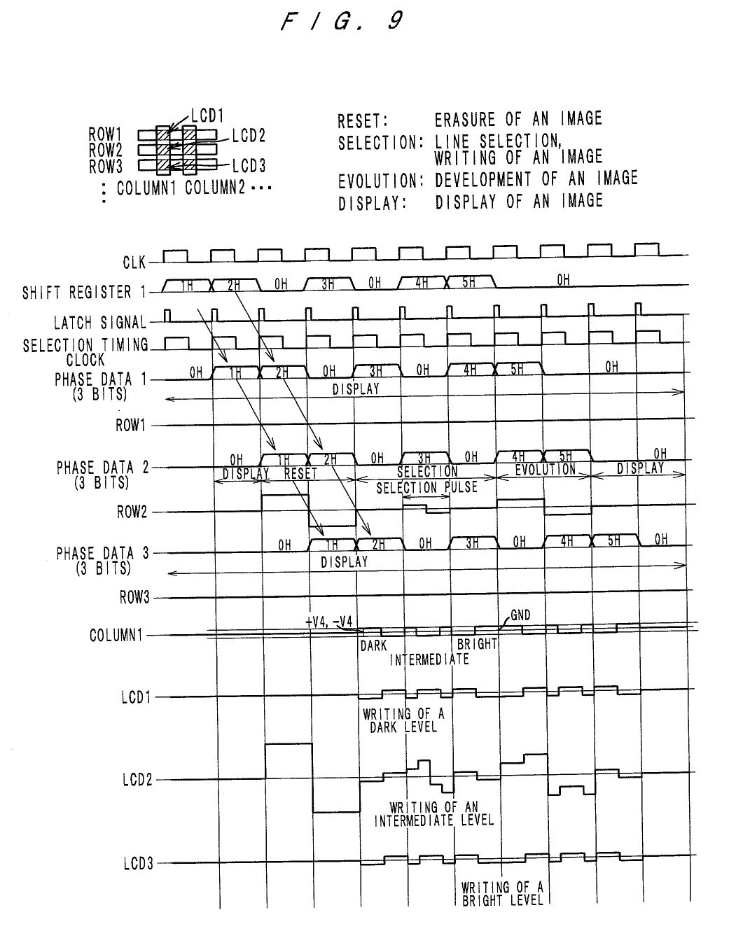

### Scanning Driving IC and Writing on Entire Screen, See FIGS. 7 and 8

FIG. 7 shows the structure of the scanning electrode driving IC 131 which outputs the driving wave. This scanning electrode driving IC 131 comprises conventional circuits, namely, a shift register 301, a phase latch 302, a decoder 303 and an analog switch 304, and further comprises a shift register 305 and a mask latch 306. The operation of the shift register 305 and the mask latch 306 which are newly provided will be described later with reference to writing on part of the screen and interlace scanning.

For writing on the entire screen, in the scanning electrode driving IC 131, as FIG. 8 shows, data for reset of ROW1 are inputted to the shift register 301 for the time of one clock and are latched therein. Thereby, a reset pulse +V1 is outputted to ROW1. Next, the data in the shift register 301 are shifted by one clock and are latched. Thereby, a reset pulse −V1 are outputted to ROW2. By repeating these processes, a specified pulse wave is applied to each of the scanning electrodes. Table 1 below is a truth table of the decoder 303 in carrying out writing on the entire screen.

TABLE 1

| | | |
|---|---|---|
| Selection Timing Clock | 0 | 1 |

| | | | | |
|---|---|---|---|---|
| Phase | Display | 000 | GND | GND |
| Data | Reset + | 001 | +V1 | +V1 |
| | Reset − | 010 | −V1 | −V1 |
| | Selection | 011 | −V2 | +V2 |
| | Evolution + | 100 | +V3 | +V3 |
| | Evolution − | 101 | −V3 | −V3 |
| | Display | 110 | GND | GND |
| | Display | 111 | GND | GND |

For writing on part of the screen, for example, for writing on only ROW2 in the case of FIG. 8, data on only ROW2 are renewed, and the frequency of the transmission clock CLK becomes thrice. Thus, in a case of writing on only one line of the three lines, the frequency of the transmission clock becomes thrice. A liquid crystal display usually has approximately 1,000 lines (scanning electrodes). In carrying out writing on only one of these 1,000 lines, the frequency of the transmission clock will become approximately 1,000 times

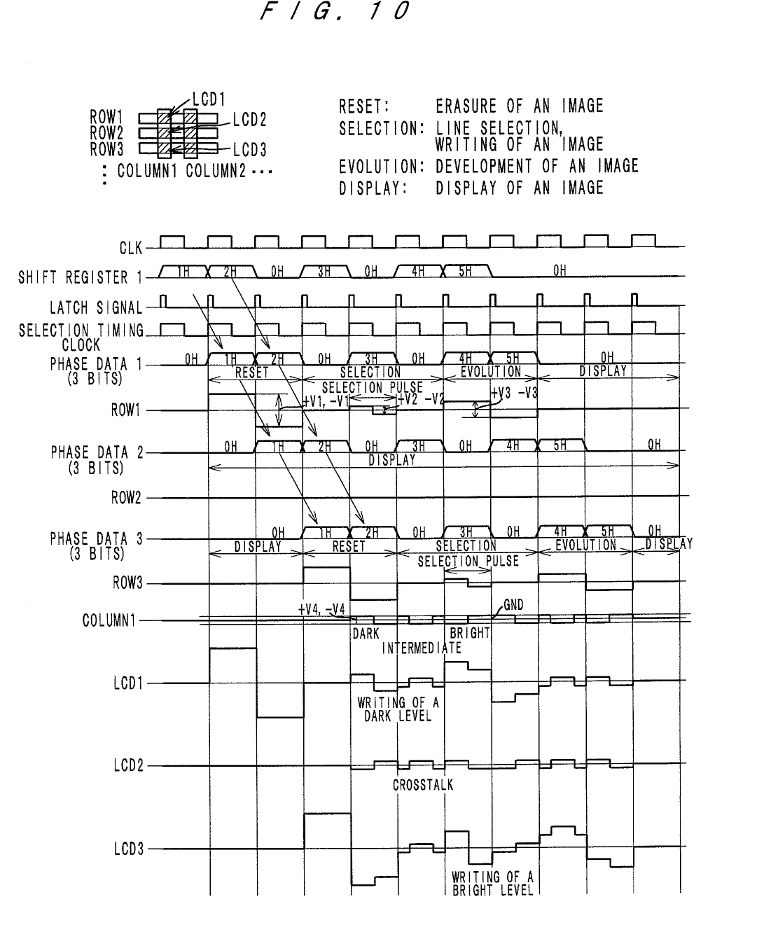

### Writing on Part of Screen; See FIG. 9

In this embodiment, as FIG. 7 shows, the scanning electrode driving IC 131 is provided with a mask latch 306, and data for the scanning electrode to be subjected to writing are shifted by the shift register beforehand and inputted to the mask latch 306. Thereby, regardless of the data of the phase latch 302, output can be controlled. In this way, the frequency of the transmission clock CLK can be kept low, and the control mechanism can be simplified.

FIG. 9 shows a driving wave for writing on part of the screen when the mask latch 306 is used. In this case, data renewal is not necessary in the entire screen, and the frequency of the transmission clock in this case is equal to that during writing on the entire screen.

Table 2 below is a truth table of the decoder 303 in carrying out writing on part of the screen.

TABLE 2

| | | | Selection Timing Clock | |
|---|---|---|---|---|
| Phase Data | | Mask Bit | 0 | 1 |
| Display | 000 | 1 | GND | GND |
| Reset + | 001 | 1 | +V1 | +V1 |
| Reset − | 010 | 1 | −V1 | −V1 |
| Selection | 011 | 1 | −V2 | +V2 |
| Evolution + | 100 | 1 | +V3 | +V3 |
| Evolution − | 101 | 1 | −V3 | −V3 |
| Display | 110 | 1 | GND | GND |
| Display | 111 | 1 | GND | GND |
| Display | Xxx | 0 | GND | GND |

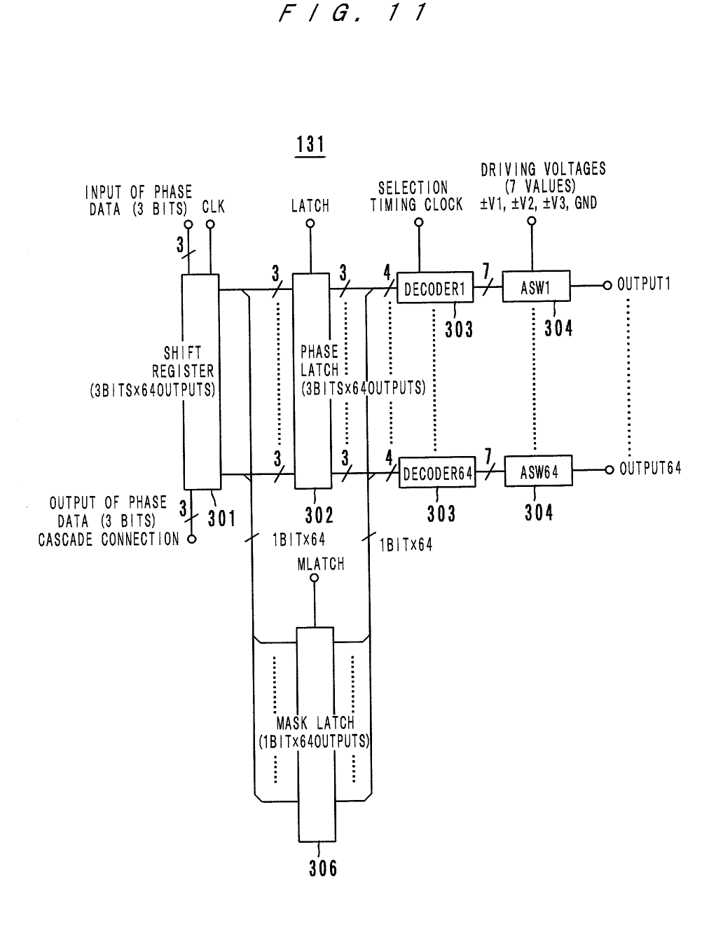

Interlace Scanning; See FIG. 10

By adopting the above-described method of writing on part of the screen, interlace scanning can be carried out with the frequency of the transmission clock kept low. Interlace scanning is a driving mode wherein one frame is divided into a plurality of fields and scanning is carried out with one or more scanning lines skipped.

FIG. 10 shows a driving wave for interlace scanning. Scanning is carried out with ROW2 skipped, that is, writing is not carried out on ROW2. The frequency of the transmission clock CLK is equal to the frequency of the transmission clock CLK shown in FIG. 9. Further, two clocks may be sent in each scanning time shown in FIG. 10, and selection of ROW1 and selection of ROW2 are carried out at a time lag corresponding to one clock; actually, however, in this case of interlace scanning, writing on ROW2, that is, data transmission for ROW 2 is not carried out.

### Modification of Scanning Electrode Driving IC; See FIG. 11

In order to permit a low-frequency drive for writing on part of the screen, as FIG. 11 shows, data may be inputted to the mask latch 306 provided in the scanning electrode driving IC 131 from the shift register 301. In this case, the shift register 305 shown in FIG. 7 is no longer necessary.

### Other Embodiments

The liquid crystal display, the control circuit and the scanning electrode driving ICs are not necessarily of the structures shown by FIGS. 1, 2, 7 and 11 respectively and may be of any other structures.

Although the present invention has been described with reference to the preferred embodiments, various changes and modifications may be possible to those who are skilled in the art. Such changes and modifications are to be understood as being within the scope of the present invention.

What is claimed is:

1. A liquid crystal display driver which drives a liquid crystal display by a matrix method by applying pulses to a plurality of scanning electrodes and a plurality of signal electrodes which face each other and cross each other substantially perpendicularly, the liquid crystal display driver comprising:
a mask bit register for controlling whether or not to apply driving pulses to each of the scanning electrodes.

2. A liquid crystal display driver according to claim 1, which drives a liquid crystal display by a simple matrix method.

3. A liquid crystal display driver according to claim 1, wherein the mask bit register is used for writing on part of the liquid crystal display.

4. A liquid crystal display driver according to claim 1, wherein the mask bit register is used for interlace scanning of the liquid crystal display.

5. A liquid crystal display driver according to claim 1, wherein the liquid crystal display comprises liquid crystal with a memory effect.

6. A liquid crystal display driver according to claim 5, wherein liquid crystal in the liquid crystal display exhibits a cholesteric phase.

7. A liquid crystal display apparatus comprising:
a liquid crystal display which comprises liquid crystal between a pair of substrates,
a driver which drives the liquid crystal display by a matrix method by applying pulses to a plurality of scanning electrodes and a plurality of signal electrodes which face each other and cross each other substantially perpendicularly, the driver comprising a mask bit register for controlling whether or not to apply driving pulses to each of the scanning electrodes.

8. A liquid crystal display apparatus according to claim 7, wherein the driver drives the liquid crystal display by a simple matrix method.

9. A liquid crystal display apparatus according to claim 7, wherein the driver uses the mask bit register for writing on part of the liquid crystal display.

10. A liquid crystal display apparatus according to claim 7, wherein the driver uses the mask bit register for interlace scanning of the liquid crystal display.

11. A liquid crystal display apparatus according to claim 7, wherein liquid crystal in the liquid crystal display has a memory effect.

12. A liquid crystal display apparatus according to claim 11, wherein the liquid crystal exhibits a cholesteric phase.
